(19) United States
(12) Patent Application Publication
(10) Pub. No.: US 2026/0301636 A1
(43) Pub. Date: Oct. 1, 2026

(54) DRIVER INTEGRATED CIRCUIT

(71) Applicant: NOVATEK Microelectronics Corp., Hsinchu (TW)

(72) Inventors: Tso-Hua CHIEN, Hsinchu City (TW); Bo-Tian LI, Tainan City (TW); Chih-Cheng CHUANG, Tainan City (TW)

(21) Appl. No.: 19/363,666

(22) Filed: Oct. 21, 2025

Related U.S. Application Data
(60) Provisional application No. 63/779,298, filed on Mar. 28, 2025.

(51) Int. Cl. G09G 3/20

(52) U.S. Cl. CPC G09G 3/2018; G09G 3/2062; G09G 2300/0426; G09G 2310/0243; G09G 2310/0267; G09G 2310/0275; G09G 2310/08; G09G 2330/021

(57) ABSTRACT

A driver integrated circuit of a display panel includes: a source driver and a controller. The source driver is coupled to the display panel. The controller is coupled to the source driver and configured to output a plurality of gate clock signals to a gate driver according to a horizontal synchronous signal. The gate driver is coupled to the display panel through a plurality of gate lines. The horizontal synchronous signal includes a plurality of time intervals, and the plurality of time intervals correspond to the plurality of gate lines respectively. A time length of one of the plurality of time intervals is M times a clock period or N times the clock period according to an accumulation error of a corresponding gate line of the plurality of gate lines, in which M and N are positive integers.

### RELATED APPLICATIONS

This application claims priority to U.S. Provisional Application Serial Number 63/779,298, filed Mar. 28, 2025, which is herein incorporated by reference.

### BACKGROUND

### Technical Field

The present disclosure relates to display technology. More particularly, the present disclosure relates to a driver integrated circuit (IC) capable of improving frame rate offsets of a display panel.

### Description of Related Art

With developments of technology, display devices are applied to various electronic devices. However, in some related approaches, a driver integrated circuit of a display device is with frame rate offsets, causing the frame rate of the display device is inaccurate.

### SUMMARY

Some aspects of the present disclosure are to a driver integrated circuit. The driver integrated circuit of a display panel includes: a source driver and a controller. The source driver is coupled to the display panel. The controller is coupled to the source driver and configured to output a plurality of gate clock signals to a gate driver according to a horizontal synchronous signal. The gate driver is coupled to the display panel through a plurality of gate lines. The horizontal synchronous signal includes a plurality of time intervals, and the plurality of time intervals correspond to the plurality of gate lines respectively. A time length of one of the plurality of time intervals is M times a clock period or N times the clock period according to an accumulation error of a corresponding gate line of the plurality of gate lines, in which M and N are positive integers.

Some aspects of the present disclosure are to a driver integrated circuit of a display panel. The driver integrated circuit includes a source driver and a controller. The source driver is coupled to the display panel. The controller is coupled to the source driver and configured to output a plurality of gate clock signals to a gate driver according to a horizontal synchronous signal. The gate driver is coupled to the display panel through a plurality of gate lines. The horizontal synchronous signal is generated according to at least one table, and the at least one table records K time intervals of the horizontal synchronous signal for K gate lines of the plurality of gate lines. An average time length of the K time intervals corresponds to an ideal scan time of the display panel.

Some aspects of the present disclosure are to a driver integrated circuit of a display panel. The driver integrated circuit includes a source driver and a controller. The source driver is coupled to the display panel. The controller is coupled to the source driver and configured to output a first gate clock signal and a second gate clock signal to a gate driver according to a horizontal synchronous signal. The gate driver is coupled to the display panel through a first gate line and a second gate line. A first time length of a first time interval of the first gate clock signal is different from a second time length of a second time interval of the second gate clock signal according to the horizontal synchronous signal which is determined by accumulation errors of the first gate line and the second gate line.

Some aspects of the present disclosure are to a driver integrated circuit of a display panel. The driver integrated circuit includes a source driver and a controller. The source driver is coupled to the display panel. The controller is coupled to the source driver and configured to output a gate clock signal to a gate driver according to a horizontal synchronous signal. The gate driver is coupled to the display panel through a plurality of gate lines. A first time length of a first time interval of the gate clock signal is different from a second time length of a second time interval of the gate clock signal according to the horizontal synchronous signal which is determined by accumulation errors of the plurality of gate lines.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a display device according to some embodiments of the present disclosure.

FIG. 2 is a schematic diagram illustrating a controller according to some embodiments of the present disclosure.

FIG. 3 is a waveform diagram illustrating a horizontal synchronous signal according to some embodiments of the present disclosure.

FIG. 4 is a schematic diagram illustrating a timing control circuit according to some embodiments of the present disclosure.

FIG. 5 is a schematic diagram illustrating a calculation circuit according to some embodiments of the present disclosure.

FIG. 6 is a schematic diagram illustrating a calculation circuit according to some embodiments of the present disclosure.

FIG. 7 is a schematic diagram illustrating the horizontal synchronous signal in FIG. 3 and multiple gate clock signals according to some embodiments of the present disclosure.

FIG. 8 is a schematic diagram illustrating a timing control circuit according to some embodiments of the present disclosure.

FIG. 9 is a schematic diagram illustrating a table according to some embodiments of the present disclosure.

FIG. 10 is a schematic diagram illustrating a table according to some embodiments of the present disclosure.

FIG. 11 is a schematic diagram illustrating two tables according to some embodiments of the present disclosure.

FIG. 12 is a schematic diagram illustrating a display device according to some embodiments of the present disclosure.

FIG. 13 is a schematic diagram illustrating a display device according to some embodiments of the present disclosure.

### DETAILED DESCRIPTION

In the present disclosure, "connected" or "coupled" may refer to “electrically connected” or “electrically coupled.” "Connected" or "coupled" may also refer to operations or actions between two or more elements.

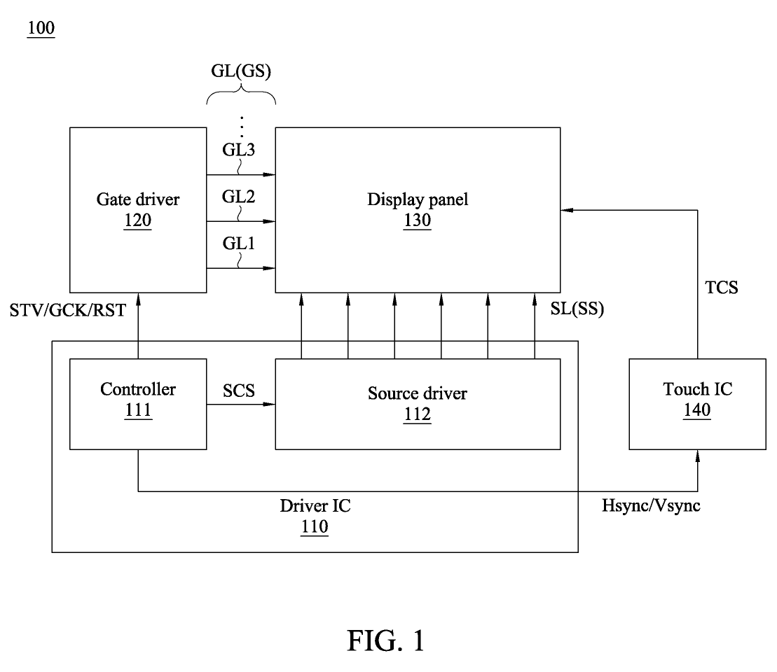

Reference is made to FIG. 1. FIG. 1 is a schematic diagram illustrating a display device 100 according to some embodiments of the present disclosure.

As illustrated in FIG. 1, the display device 100 includes a driver integrated circuit (IC) 110, a gate driver 120, a display panel 130, and a touch integrated circuit 140.

In FIG. 1, the display panel 130 is a panel with both of the display function and the touch function. In some embodiments, the display panel 130 is an organic light emitting diode panel or a liquid crystal panel, but the present disclosure is not limited thereto.

The driver integrated circuit 110 is coupled to the gate driver 120, the display panel 130, and the touch integrated circuit 140. The gate driver 120 is coupled to the display panel 130 through gate lines GL. The display panel 130 is coupled to the touch integrated circuit 140.

The driver integrated circuit 110 includes a controller 111 and a source driver 112.

The controller 111 is coupled to the source driver 112. The controller 111 is coupled to the gate driver 120 and the touch integrated circuit 140. The source driver 112 is coupled to the display panel 130 through source lines SL.

Regarding operations, the controller 111 generates and transmits a source control signal SCS to the source driver 112. The source driver 112 generates and transmits source line signals SS to the display panel 130 according to the source control signal SCS. In addition, the controller 111 generates and transmits a start signal STV, gate cock signals GCK, and a reset signal RST to the gate driver 120. The gate driver 120 generates and transmits gate line signals GS to the display panel 130 according to the start signal STV, the gate cock signals GCK, and the reset signal RST. Then, the display panel 130 displays corresponding images according to the source line signals SS from the source driver 112 and the gate line signals GS from the gate driver 120.

In addition, the controller 111 generates a horizontal synchronous signal Hsync and a vertical synchronous signal Vsync, and transmits the horizontal synchronous signal Hsync and the vertical synchronous signal Vsync to the touch integrated circuit 140. The touch integrated circuit 140 generates and transmits a touch control signal TCS to the display panel 130 according to the horizontal synchronous signal Hsync and the vertical synchronous signal Vsync so as to control the touch function of the display panel 130.

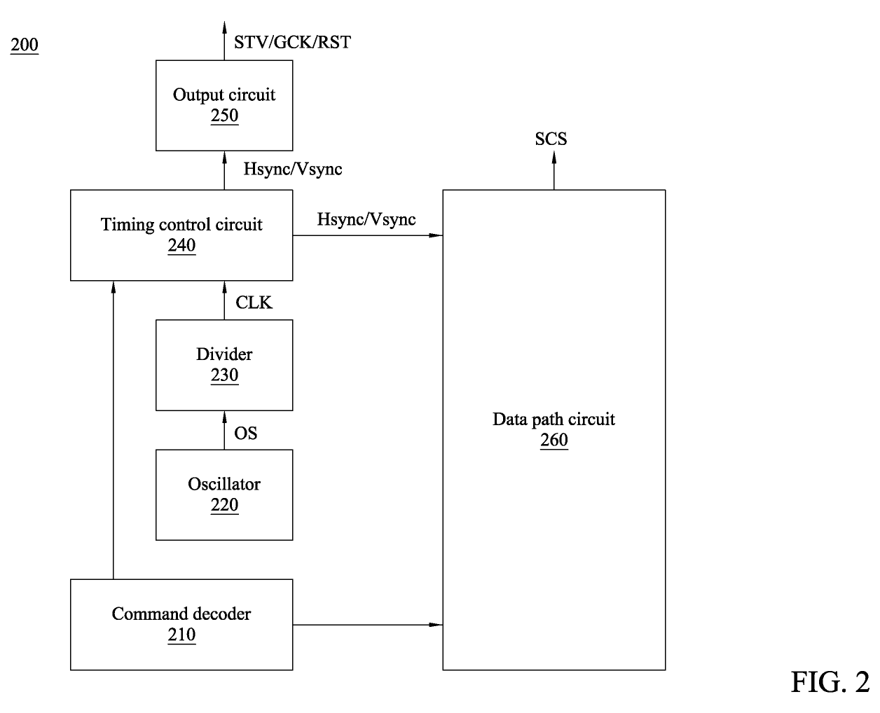

Reference is made to FIG. 2. FIG. 2 is a schematic diagram illustrating a controller 200 according to some embodiments of the present disclosure.

In some embodiments, the controller 200 is used to implement the controller 111 in FIG. 1.

As illustrated in FIG. 2, the controller 200 includes a command decoder 210, an oscillator 220, a divider 230, a timing control circuit 240, an output circuit 250, and a data path circuit 260.

The command decoder 210 is coupled to the timing control circuit 240 and the data path circuit 260. The oscillator 220 is coupled to the divider 230. The divider 230 is coupled to the timing control circuit 240. The timing control circuit 240 is coupled to the output circuit 250 and the data path circuit 260.

Regarding operations, the command decoder 210 generates and transmits signals related to image data to the timing control circuit 240 and the data path circuit 260. The oscillator 220 generates and transmits an oscillation signal OS to the divider 230. The divider 230 divides a frequency of the oscillation signal OS to generate a clock signal CLK and to transmit the clock signal CLK to the timing control circuit 240. In general, the clock signal CLK has a clock period. The timing control circuit 240 generates and transmits the horizontal synchronous signal Hsync and the vertical synchronous signal Vsync to the output circuit 250 and the data path circuit 260 according to the clock signal CLK and the signals from the command decoder 210. The output circuit 250 generates and outputs the start signal STV, the gate cock signals GCK, and the reset signal RST according to the horizontal synchronous signal Hsync and the vertical synchronous signal Vsync. The data path circuit 260 generates and outputs the source control signal SCS according to the horizontal synchronous signal Hsync, the vertical synchronous signal Vsync, and the signals from the command decoder 210.

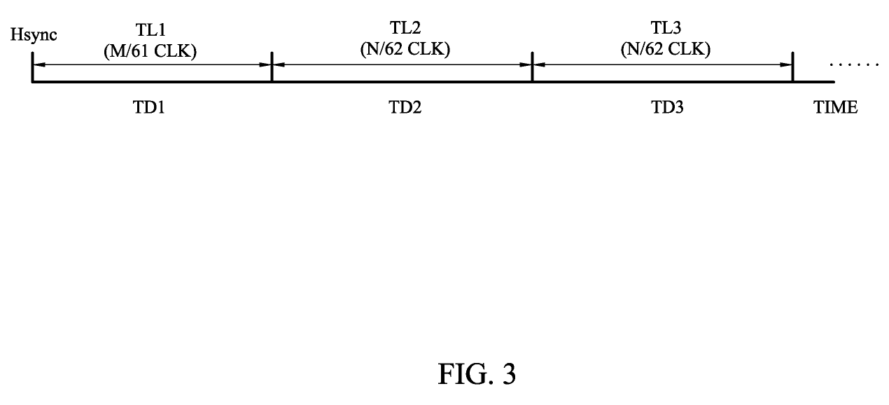

Reference is made to FIG. 3. FIG. 3 is a waveform diagram illustrating the horizontal synchronous signal Hsync according to some embodiments of the present disclosure.

As illustrated in FIG. 3, the horizontal synchronous signal Hsync includes multiple time intervals, and these time intervals correspond to the gate lines GL in FIG. 1 respectively. For better understanding, FIG. 3 merely illustrates three time intervals TD1, TD2, and TD3. The time interval TD1 corresponds to the gate line GL1, the time interval TD2 corresponds to the gate line GL2, the time interval TD3 corresponds to the gate line GL3, and so on.

In the present disclosure, a time length of one of these time intervals TD1-TD3 is M times the clock period of the clock signal CLK or N times the clock period of the clock signal CLK according to an accumulation error of a corresponding gate line. M and N are positive integers and are different from each other. For example, when a frame rate of the display panel 130 corresponds to an ideal scan time for each gate line GL, M times the clock period of the clock signal CLK is less than the ideal scan time, and N times the clock period of the clock signal CLK is greater than the ideal scan time. In some embodiments, N is equal to M plus 1, but the present disclosure is not limited thereto.

In this exemplary embodiment, it is assumed that the frame rate of the display panel 130 is 144 Hz, the ideal scan time for each gate line GL is 61.713 times the clock period of the clock signal CLK. As illustrated in FIG. 3, the time length TL1 of the time interval TD1 is determined to be 61 times the clock period of the clock signal CLK according to an accumulation error of the gate line GL1. The time length TL2 of the time interval TD2 is determined to be 62 times the clock period of the clock signal CLK according to an accumulation error of the gate line GL2. The time length TL3 of the time interval TD3 is determined to be 62 times the clock period of the clock signal CLK according to an accumulation error of the gate line GL3. How to determine the time lengths TL1-TL3 of the time intervals TD1-TD3 is described in following paragraphs.

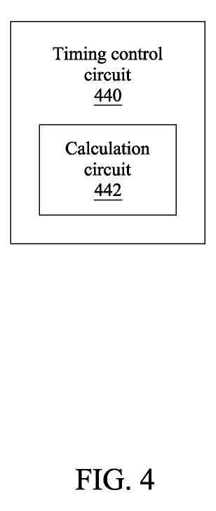

Reference is made to FIG. 4. FIG. 4 is a schematic diagram illustrating a timing control circuit 440 according to some embodiments of the present disclosure.

In some embodiments, the timing control circuit 440 is used to implement the timing control circuit 240 in FIG. 2.

As illustrated in FIG. 4, the timing control circuit 440 includes a calculation circuit 442. The calculation circuit 442 calculates the aforementioned accumulation errors. In some other embodiments, the calculation circuit 442 is disposed outside the timing control circuit 440.

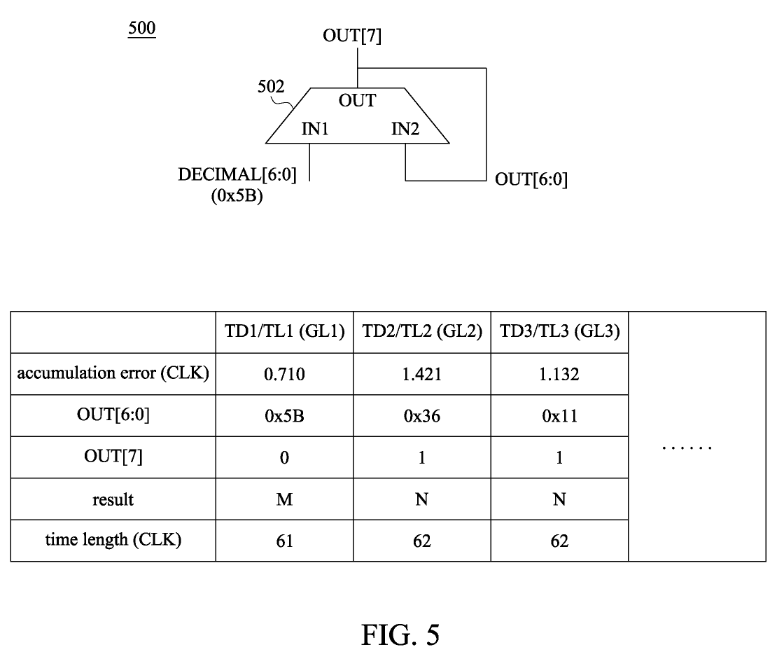

Reference is made to FIG. 5. FIG. 5 is a schematic diagram illustrating a calculation circuit 500 according to some embodiments of the present disclosure.

In some embodiments, the calculation circuit 500 is used to implement the calculation circuit 442 in FIG. 4.

As illustrated in FIG. 5, the calculation circuit 500 includes an adder 502. The adder 502 includes an input terminal IN1, an input terminal IN2, and an output terminal OUT.

The input terminal IN1 receives a decimal set value DECIMAL[6:0]. The decimal set value DECIMAL[6:0] is set to correspond to a difference between the ideal scan time and M times the clock period of the clock signal CLK. Taking the aforementioned embodiment as an example, the ideal scan time for each gate line GL is 61.713 times the clock period of the clock signal CLK, and M is 61 times the clock period of the clock signal CLK. Thus, the decimal set value DECIMAL[6:0] corresponds to (is close to) the difference between 61.713 times the clock period of the clock signal CLK and 61 times the clock period of the clock signal CLK. In this case, the decimal set value DECIMAL[6:0] is set to be 0.710 (i.e., 0x5B) which is less than 1, and the unit of the decimal set value DECIMAL[6:0] is the clock period of the clock signal CLK.

An accumulation error of one gate line GL includes a first part OUT[6:0] and a second part OUT[7]. The input terminal IN2 receives the first part OUT[6:0]. The adder 502 adds the first part OUT[6:0] and the decimal set value DECIMAL[6:0] to generate an accumulation error for a next gate line GL. The output terminal OUT outputs the second part OUT[7]. The second part OUT[7] is used to determine that a corresponding time length is M or N times the clock period of the clock signal CLK. To be more specific, for the time interval TD1, when the accumulation error of the gate line GL1 is 0.710 which is less than 1, the time length TL1 of the time interval TD1 is set to be M times the clock period of the clock signal CLK.

For the time interval TD2, the adder 522 adds the accumulation error of the gate line GL1 and the decimal set value DECIMAL[6:0] to be the accumulation error of the gate line GL2. When the accumulation error of the gate line GL2 is 1.421 which is equal to or greater than 1, the time length TL2 of the time interval TD2 is set to be N times the clock period of the clock signal CLK. The difference between the accumulation error of the gate line GL2 and 1 is a remain accumulation error of the gate line GL2, and the remain accumulation error is to be the first part OUT[6:0]. On the contrary, when the accumulation error of the gate line GL2 is less than 1, the time length TL2 of the time interval TD2 is set to be M times the clock period of the clock signal CLK.

For the time interval TD3, the adder 522 adds the remain accumulation error of the gate line GL2 and the decimal set value DECIMAL[6:0] to be the accumulation error of the gate line GL3. When the accumulation error of the gate line GL3 is 1.132 which is equal to or greater than 1, the time length TL3 of the time interval TD3 is set to be N times the clock period of the clock signal CLK. The difference between the accumulation error of the gate line GL3 and 1 is a remain accumulation error of the gate line GL3, and the remain accumulation error is to be the first part OUT[6:0]. On the contrary, when the accumulation error of the gate line GL3 is less than 1, the time length TL3 of the time interval TD3 is set to be M times the clock period of the clock signal CLK.

The subsequent time intervals have similar operations, so they are not described herein again.

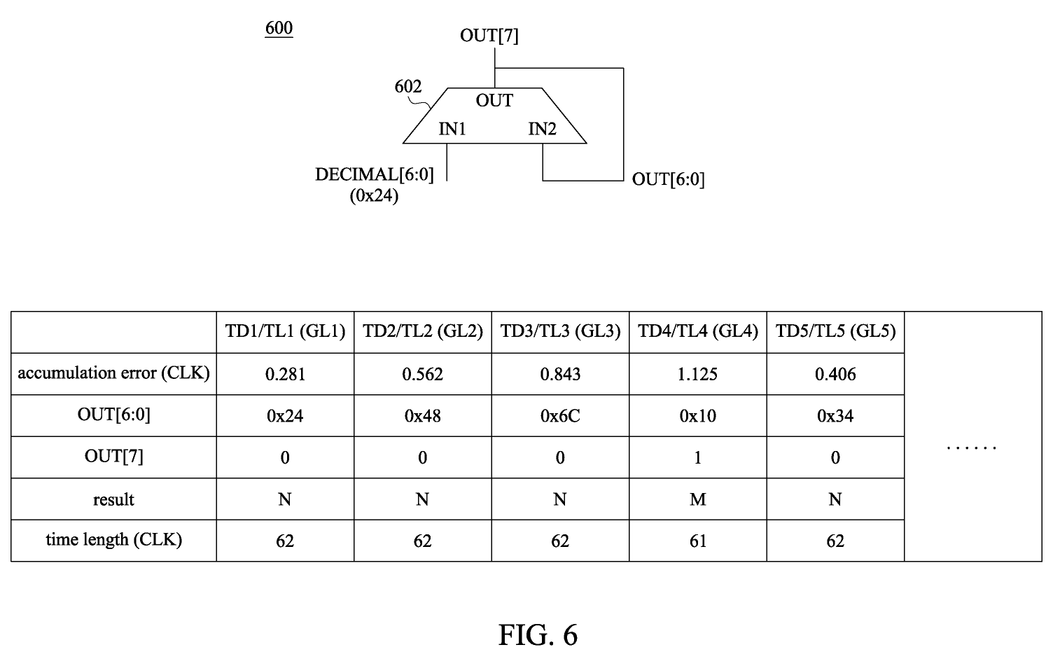

Reference is made to FIG. 6. FIG. 6 is a schematic diagram illustrating a calculation circuit 600 according to some embodiments of the present disclosure. FIG. 6 illustrates another case.

As illustrated in FIG. 6, the calculation circuit 600 includes an adder 602. Similar to the adder 502, the adder 602 includes an input terminal IN1, an input terminal IN2, and an output terminal OUT.

The input terminal IN1 receives a decimal set value DECIMAL[6:0]. The decimal set value DECIMAL[6:0] is set to correspond to a difference between N times the clock period of the clock signal CLK and the ideal scan time. Taking the aforementioned embodiment as an example, N is 62 times the clock period of the clock signal CLK, and the ideal scan time for each gate line GL is 61.713 times the clock period of the clock signal CLK. Thus, the decimal set value DECIMAL[6:0] corresponds to (is close to) the difference between 62 times the clock period of the clock signal CLK and 61.713 times the clock period of the clock signal CLK. In this case, the decimal set value DECIMAL[6:0] is set to be 0.281 (i.e., 0x24) which is less than 1, and the unit of the decimal set value DECIMAL[6:0] is the clock period of the clock signal CLK.

An accumulation error of one gate line GL includes a first part OUT[6:0] and a second part OUT[7]. The input terminal IN2 receives the first part OUT[6:0]. The adder 602 adds the first part OUT[6:0] and the decimal set value DECIMAL[6:0] to generate an accumulation error for a next gate line GL. The output terminal OUT outputs the second part OUT[7]. The second part OUT[7] is used to determine that a corresponding time length is M or N times the clock period of the clock signal CLK. To be more specific, for a time interval TD1, when the accumulation error of the gate line GL1 is 0.281 which is less than 1, a time length TL1 of the time interval TD1 is set to be N times the clock period of the clock signal CLK.

For a time interval TD2, the adder 622 adds the accumulation error of the gate line GL1 and the decimal set value DECIMAL[6:0] to be the accumulation error of the gate line GL2. When the accumulation error of the gate line GL2 is 0.562 which is less than 1, a time length TL2 of the time interval TD2 is set to be N times the clock period of the clock signal CLK. On the contrary, when the accumulation error of the gate line GL2 is equal to or greater than 1, the time length TL2 of the time interval TD2 is set to be M times the clock period of the clock signal CLK.

For a time interval TD3, the adder 622 adds the accumulation error of the gate line GL2 and the decimal set value DECIMAL[6:0] to be the accumulation error of the gate line GL3. When the accumulation error of the gate line GL3 is 0.843 which is less than 1, a time length TL3 of the time interval TD3 is set to be N times the clock period of the clock signal CLK. On the contrary, when the accumulation error of the gate line GL3 is equal to or greater than 1, the time length TL3 of the time interval TD3 is set to be M times the clock period of the clock signal CLK.

For a time interval TD4, the adder 622 adds the accumulation error of the gate line GL3 and the decimal set value DECIMAL[6:0] to be the accumulation error of the gate line GL4. When the accumulation error of the gate line GL4 is 1.125 which is equal to or greater than 1, a time length TL4 of the time interval TD4 is set to be M times the clock period of the clock signal CLK. The difference between the accumulation error of the gate line GL4 and 1 is a remain accumulation error of the gate line GL4, and the remain accumulation error is to be the first part OUT[6:0]. On the contrary, when the accumulation error of the gate line GL4 is less than 1, the time length TL4 of the time interval TD4 is set to be N times the clock period of the clock signal CLK.

For a time interval TD5, the adder 622 adds the remain accumulation error of the gate line GL4 and the decimal set value DECIMAL[6:0] to be the accumulation error of the gate line GL5. When the accumulation error of the gate line GL5 is 0.406 which is less than 1, a time length TL5 of the time interval TD5 is set to be N times the clock period of the clock signal CLK. The accumulation error of the gate line GL5 is also a remain accumulation error of the gate line GL5 and is to be the first part OUT[6:0]. On the contrary, when the accumulation error of the gate line GL5 is equal to or greater than 1, the time length TL5 of the time interval TD5 is set to be M times the clock period of the clock signal CLK.

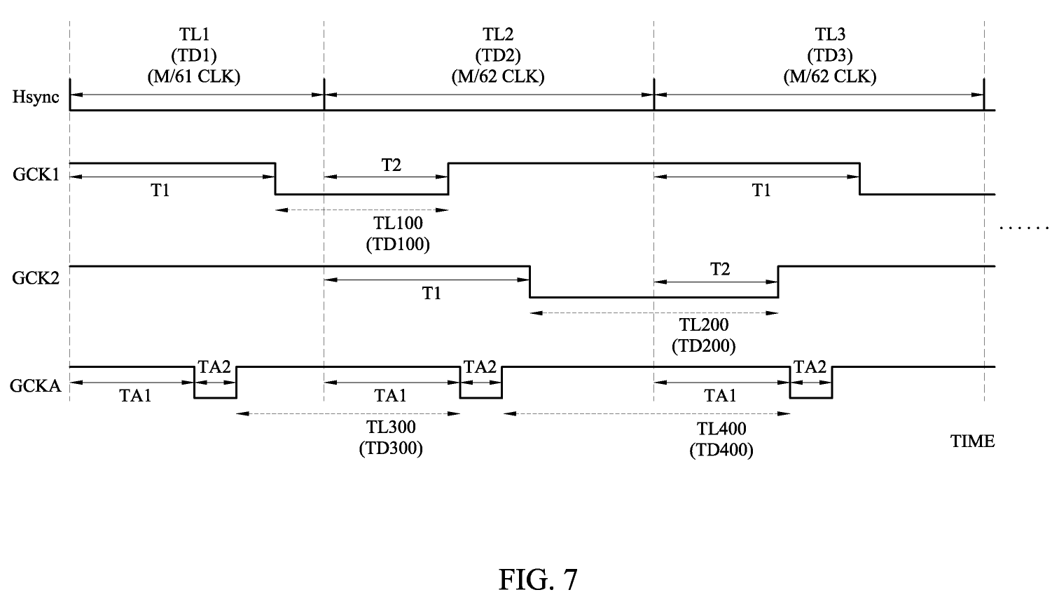

Reference is made to FIG. 7. FIG. 7 is a schematic diagram illustrating the horizontal synchronous signal Hsync in FIG. 3 and multiple gate clock signals GCK1, GCK2, and GCKA according to some embodiments of the present disclosure.

At first, the gate clock signal GCK1 and the gate clock signal GCK2 are taken as an example. The gate clock signal GCK1 and the gate clock signal GCK2 are used to control the gate line signal on the gate line GL1 and the gate line signal on the gate line GL2 in FIG. 1 respectively. The gate clock signal GCK1 is pulled down after a time length T1 from the first pulse of the horizontal synchronous signal Hsync and then is pulled up after a time length T2 from the second pulse of the horizontal synchronous signal Hsync. The gate clock signal GCK2 is pulled down after the time length T1 from the second pulse of the horizontal synchronous signal Hsync and then is pulled up after the time length T2 from the third pulse of the horizontal synchronous signal Hsync. Since the time length TL1 is different from the time length TL2, a time length TL100 of a time interval TD100 is different from a time length TL200 of a time interval TD200. In other words, the time length TL100 is different from the time length TL200 according to the horizontal synchronous signal Hsync which is determined by the accumulation errors of the gate line GL1 and the gate line GL2. In this case, the time length TL100 of the time interval TD100 is shorter than the time length TL200 of the time interval TD200.

Then, the gate clock signal GCKA is taken as an example. The gate clock signal GCKA is used to control the all gate line signals on the all gate lines GL in FIG. 1. The gate clock signal GCKA is pulled down after a time length TA1 from each pulse of the horizontal synchronous signal Hsync and then is pulled up after a time length TA2. Since the time length TL1 is different from the time length TL2, a time length TL300 of a time interval TD300 is different from a time length TL400 of a time interval TD400. In other words, the time length TL300 is different from the time length TL400 according to the horizontal synchronous signal Hsync which is determined by the accumulation errors of the gate lines GL. In this case, the time length TL300 of the time interval TD300 is shorter than the time length TL400 of the time interval TD400.

In general, each time lengths of each time interval of the horizontal synchronous signal is a fixed integer multiple of the clock period of the clock signal. This would cause frame rate offsets. In some related approaches, the frame rate offsets are improved by adjusting a frequency of the clock signal or adjusting the oscillation signal. However, these increase circuit synthesis difficulty and power consumption.

Compared to the aforementioned related approaches, in the present disclosure, the time length TL1-TL3 of each one of the time intervals TD1-TD3 of the horizontal synchronous signal Hsync is set to be M times or N times the clock period of the clock signal CLK according to the accumulation error of a corresponding gate line. This significantly improves the frame rate offsets without adjusting the frequency of the clock signal CLK or adjusting the oscillation signal OS and this is not easily perceived by human eyes. Therefore, circuit synthesis difficulty and power consumption would not increase.

Reference is made to FIG. 1 again. The display device 100 could have different operations, and time sequence of these operations are controlled by different gate shift registers. These gate shift registers would use different start signal STV and different gate cock signals GCK to turn on corresponding lines sequentially.

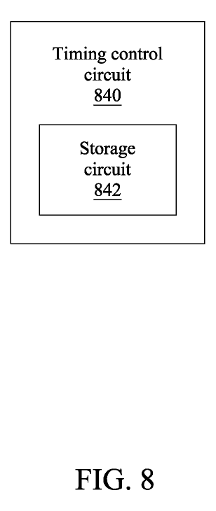

Reference is made to FIG. 8. FIG. 8 is a schematic diagram illustrating a timing control circuit 840 according to some embodiments of the present disclosure.

In some embodiments, the timing control circuit 840 is used to implement the timing control circuit 240 in FIG. 2.

As illustrated in FIG. 8, the timing control circuit 840 includes a storage circuit 842. The storage circuit 842 stores at least one table. In some embodiments, the storage circuit 842 is a register or a memory. In some other embodiments, the storage circuit 842 is disposed outside the timing control circuit 840.

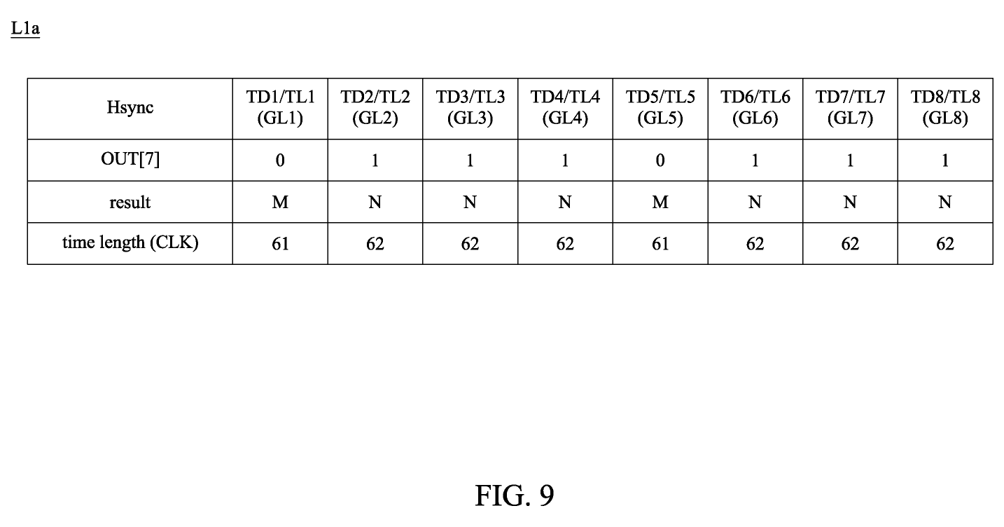

Reference is made to FIG. 9. FIG. 9 is a schematic diagram illustrating a table L1a according to some embodiments of the present disclosure.

In some embodiments, the table L1a is stored in the storage circuit 842 in FIG. 8, and the horizontal synchronous signal Hsync is generated according to the table L1a.

The table L1a records K time intervals of the horizontal synchronous signal Hsync for K gate lines of the gate lines GL. In this example, the table L1a records 8 time intervals TD1-TD8 of the horizontal synchronous signal Hsync for 8 gate lines GL1-GL8 of the gate lines GL. For example, the time interval TD1 is for the gate line GL1, the time interval TD2 is for the gate line GL2, the time interval TD3 is for the gate line GL3, the time interval TD4 is for the gate line GL4, the time interval TD5 is for the gate line GL5, the time interval TD6 is for the gate line GL6, the time interval TD7 is for the gate line GL7, and the time interval TD8 is for the gate line GL8.

An average time length of these time intervals TD1-TD8 corresponds to the ideal scan time of the display panel 130. It is assumed that the ideal scan time of the display panel 130 for each gate line GL is 61.75 times the clock period of the clock signal CLK. Time lengths TL1-TL8 of these time interval TD1-TD8 could be predetermined to be equal to 61, 62, 62, 62, 61, 62, 62, and 62 times the clock period of the clock signal CLK respectively such that the average time length of these time intervals TD1-TD8 is equal to or is close to 61.75 times the clock period of the clock signal CLK.

In some embodiments, the table L1a is a circulation table. In other words, subsequent each 8 time intervals are also predetermined to be equal to 61, 62, 62, 62, 61, 62, 62, and 62 times the clock period of the clock signal CLK respectively according to the table L1a.

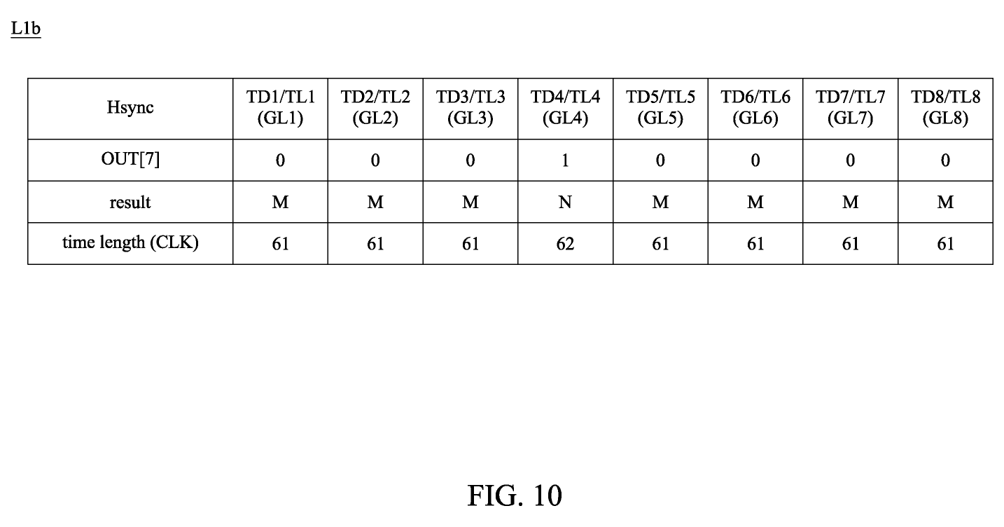

Reference is made to FIG. 10. FIG. 10 is a schematic diagram illustrating a table L1b according to some embodiments of the present disclosure.

In some embodiments, the table L1b is stored in the storage circuit 842 in FIG. 8, and the horizontal synchronous signal Hsync is generated according to the table L1b.

Similarly, the table L1b records K time intervals of the horizontal synchronous signal Hsync for K gate lines of the gate lines GL. In this example, the table L1b records 8 time intervals TD1-TD8 of the horizontal synchronous signal Hsync for 8 gate lines GL1-GL8 of the gate lines GL. For example, the time interval TD1 is for the gate line GL1, the time interval TD2 is for the gate line GL2, the time interval TD3 is for the gate line GL3, the time interval TD4 is for the gate line GL4, the time interval TD5 is for the gate line GL5, the time interval TD6 is for the gate line GL6, the time interval TD7 is for the gate line GL7, and the time interval TD8 is for the gate line GL8.

An average time length of these time intervals TD1-TD8 corresponds to the ideal scan time of the display panel 130. It is assumed that the ideal scan time of the display panel 130 for each gate line GL is 61.125 times the clock period of the clock signal CLK. Time lengths TL1-TL8 of these time interval TD1-TD8 could be predetermined to be equal to 61, 61, 61, 62, 61, 61, 61, and 61 times the clock period of the clock signal CLK respectively such that the average time length of these time intervals TD1-TD8 is equal to or is close to 61.125 times the clock period of the clock signal CLK.

In some embodiments, the table L1b is a circulation table. In other words, subsequent each 8 time intervals are also predetermined to be equal to 61, 61, 61, 62, 61, 61, 61, and 61 times the clock period of the clock signal CLK respectively according to the table L1b.

Compared to the aforementioned related approaches, in the present disclosure, each of the time lengths TL1-TL8 of the horizontal synchronous signal Hsync is set to be M times or N times the clock period of the clock signal CLK according to the table L1a or the table L1b such that the average time length is equal to or is close to the ideal scan time of the display panel 130. This significantly improves the frame rate offsets without adjusting the frequency of the clock signal CLK or adjusting the oscillation signal OS and this is not easily perceived by human eyes. Therefore, circuit synthesis difficulty and power consumption would not increase.

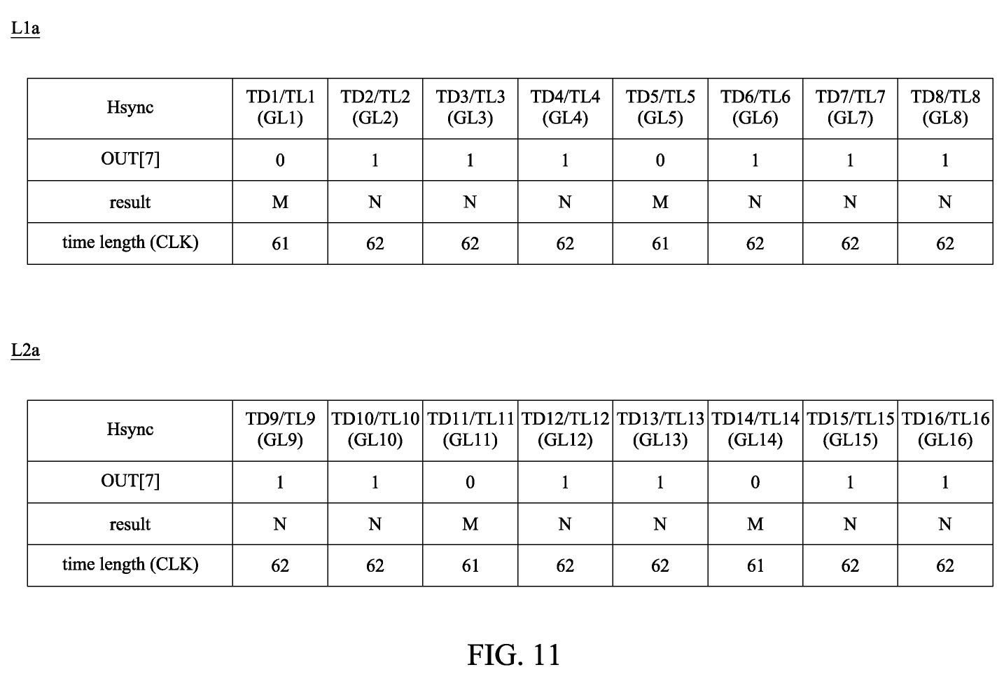

Reference is made to FIG. 11. FIG. 11 is a schematic diagram illustrating two tables L1a and L2a according to some embodiments of the present disclosure.

In some embodiments, the table L1a and the table L2a are stored in the storage circuit 842 in FIG. 8, and the horizontal synchronous signal Hsync is generated according to the table L1 and the table L2.

In this case, the table L1a in FIG. 11 is the same to the table L1a in FIG. 9, so it is not described herein again.

In addition, the table L2a records K time intervals of the horizontal synchronous signal Hsync for K gate lines of the gate lines GL. In this example, the table L2a records 8 time intervals TD9-TD16 of the horizontal synchronous signal Hsync for 8 gate lines GL9-GL16 of the gate lines GL. For example, the time interval TD9 is for the gate line GL9, the time interval TD10 is for the gate line GL10, the time interval TD11 is for the gate line GL11, the time interval TD12 is for the gate line GL12, the time interval TD13 is for the gate line GL13, the time interval TD14 is for the gate line GL14, the time interval TD15 is for the gate line GL15, and the time interval TD16 is for the gate line GL16.

An average time length of these time intervals TD9-TD16 corresponds to the ideal scan time of the display panel 130. It is assumed that the ideal scan time of the display panel 130 for each gate line GL is 61.75 times the clock period of the clock signal CLK. Time lengths TL9-TL16 of these time interval TD9-TD16 could be predetermined to be equal to 62, 62, 61, 62, 62, 61, 62, and 62 times the clock period of the clock signal CLK respectively such that the average time length of these time intervals TD9-TD16 is equal to or is close to 61.75 times the clock period of the clock signal CLK.

The order of the time lengths of the K time intervals in the table L1a is different from the order of the time lengths of the K time intervals in the table L2a. As illustrated in FIG. 11, the order of the time lengths TL1-TL8 of the time intervals TD1-TD8 in the table L1a is predetermined to be equal to 61, 62, 62, 62, 61, 62, 62, and 62 times the clock period of the clock signal CLK. The order of the time lengths TL9-TL16 of the time intervals TD9-TD16 in the table L2a is predetermined to be equal to 62, 62, 61, 62, 62, 61, 62, and 62 times the clock period of the clock signal CLK.

In some embodiments, the table L1a and the table L2a are circulation tables. In other words, the table L1a and the table L2a are utilized sequentially, alternately, or randomly to correspond to the gate lines GL such that the average time length of all time intervals corresponds to the ideal scan time of the display panel 130.

For example, the first group of 8 time intervals is determined by the table L1a, the second group of 8 time intervals is determined by the table L2a, the third group of 8 time intervals is determined by the table L1a, the fourth group of 8 time intervals is determined by the table L2a, and so on.

For example, the first group of 8 time intervals is determined by the table L1a, the second group of 8 time intervals is determined by the table L2a, the third group of 8 time intervals is determined by the table L2a, the fourth group of 8 time intervals is determined by the table L1a, and so on.

Compared to one table in FIGS. 9 and 10,11 utilizes more tables such that the randomness of the time intervals is higher and this is less likely to be perceived by human eyes.

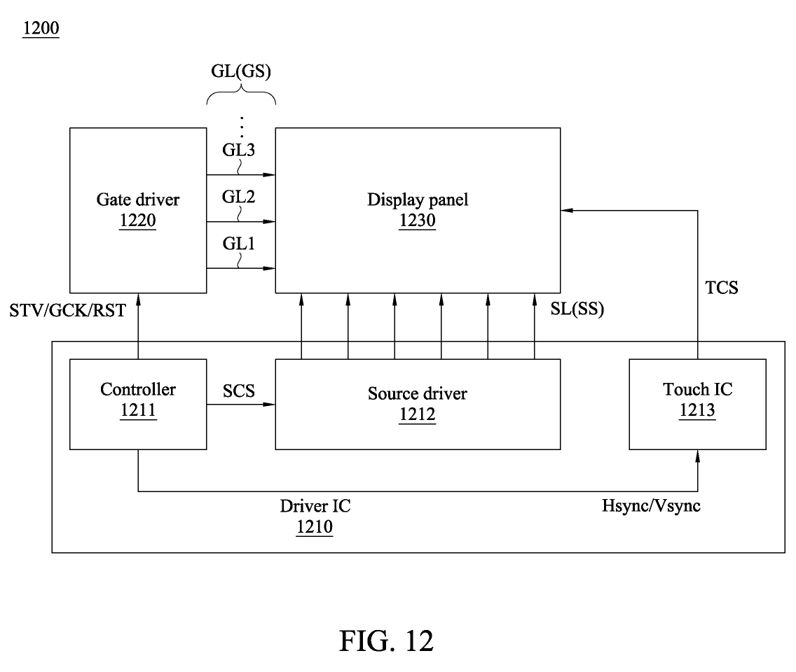

Reference is made to FIG. 12. FIG. 12 is a schematic diagram illustrating a display device 1200 according to some embodiments of the present disclosure.

As illustrated in FIG. 12, the display device 1200 includes a driver integrated circuit 1210, a gate driver 1220, and a display panel 1230. The driver integrated circuit 1210 includes a controller 1211, a source driver 1212, and a touch integrated circuit 1213. The controller 1211, the source driver 1212, the touch integrated circuit 1213, the gate driver 1220, and the display panel 1230 in FIG. 12 are similar to the controller 111, the source driver 112, the touch integrated circuit 140, the gate driver 120, and the display panel 130 in FIG. 1 respectively. One of major differences between the display device 1200 in FIG. 12 and the display device 100 in FIG. 1 is that the touch integrated circuit 1213 is disposed in the driver integrated circuit 1210.

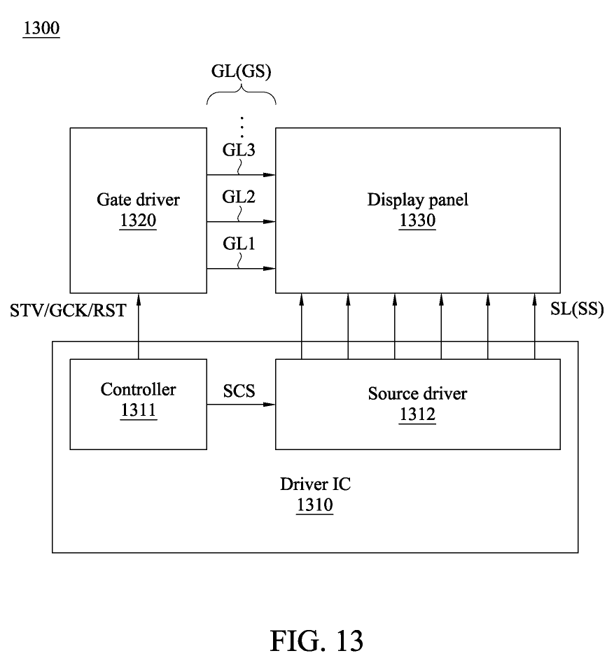

Reference is made to FIG. 13. FIG. 13 is a schematic diagram illustrating a display device 1300 according to some embodiments of the present disclosure.

As illustrated in FIG. 13, the display device 1300 includes a driver integrated circuit 1310, a gate driver 1320, and a display panel 1330. The driver integrated circuit 1310 includes a controller 1311 and a source driver 1312. The controller 1311, the source driver 1312, the gate driver 1320, and the display panel 1330 in FIG. 13 are similar to the controller 111, the source driver 112, the gate driver 120, and the display panel 130 in FIG. 1 respectively. One of major differences between the display device 1300 in FIG. 13 and the display device 100 in FIG. 1 is that the display panel 1330 is only with the display function and without the touch function.

Based on the descriptions above, in the present disclosure, the frame rate offsets are improved without adjusting the frequency of the clock signal or adjusting the oscillation signal and this method is not easily perceived by human eyes. Therefore, circuit synthesis difficulty and power consumption would not increase.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A driver integrated circuit (IC) of a display panel, comprising:
a source driver coupled to the display panel; and
a controller coupled to the source driver and configured to output a plurality of gate clock signals to a gate driver according to a horizontal synchronous signal, wherein the gate driver is coupled to the display panel through a plurality of gate lines,
wherein the horizontal synchronous signal comprises a plurality of time intervals, and the plurality of time intervals correspond to the plurality of gate lines respectively,
wherein a time length of one of the plurality of time intervals is M times a clock period or N times the clock period according to an accumulation error of a corresponding gate line of the plurality of gate lines, wherein M and N are positive integers.

2. The driver integrated circuit of the display panel of claim 1, wherein the controller comprises:
a timing control circuit configured to generate the horizontal synchronous signal according to a clock signal; and
an output circuit configured to output the plurality of gate clock signals according to the horizontal synchronous signal.

3. The driver integrated circuit of the display panel of claim 1, wherein the M times the clock period is less than an ideal scan time of the display panel, and the N times the clock period is greater than the ideal scan time.

4. The driver integrated circuit of the display panel of claim 3, wherein N is equal to M plus 1.

5. The driver integrated circuit of the display panel of claim 3, wherein the ideal scan time corresponds to a frame rate of the display panel.

6. The driver integrated circuit of the display panel of claim 3, wherein the plurality of gate lines comprise a first gate line,
wherein when the accumulation error of the first gate line is less than 1, the time length corresponding to the first gate line is the M times the clock period.

7. The driver integrated circuit of the display panel of claim 6, wherein a decimal set value corresponds to a first difference between the ideal scan time and the M times the clock period, and the decimal set value is less than 1,
wherein the plurality of gate lines further comprise a second gate line,
wherein the controller comprises:
an adder configured to add the accumulation error of the first gate line and the decimal set value to be the accumulation error of the second gate line,
wherein when the accumulation error of the second gate line is equal to or greater than 1, the time length corresponding to the second gate line is the N times the clock period,
wherein when the accumulation error of the second gate line is less than 1, the time length corresponding to the second gate line is the M times the clock period.

8. The driver integrated circuit of the display panel of claim 7, wherein when the time length corresponding to the second gate line is the N times the clock period, a second difference between the accumulation error of the second gate line and 1 is a remain accumulation error of the second gate line.

9. The driver integrated circuit of the display panel of claim 8, wherein the plurality of gate lines further comprise a third gate line,
wherein the adder is further configured to add the remain accumulation error of the second gate line and the decimal set value to be the accumulation error of the third gate line,
wherein when the accumulation error of the third gate line is equal to or greater than 1, the time length corresponding to the third gate line is the N times the clock period,
wherein when the accumulation error of the third gate line is less than 1, the time length corresponding to the third gate line is the M times the clock period.

10. The driver integrated circuit of the display panel of claim 3, wherein the plurality of gate lines comprise a first gate line,
wherein when the accumulation error of the first gate line is less than 1, the time length corresponding to the first gate line is the N times the clock period.

11. The driver integrated circuit of the display panel of claim 10, wherein a decimal set value corresponds to a first difference between the N times the clock period and the ideal scan time, and the decimal set value is less than 1,
wherein the plurality of gate lines further comprise a second gate line,
wherein the controller comprises:
an adder configured to add the accumulation error of the first gate line and the decimal set value to be the accumulation error of the second gate line,
wherein when the accumulation error of the second gate line is less than 1, the time length corresponding to the second gate line is the N times the clock period,
wherein when the accumulation error of the second gate line is equal to or greater than 1, the time length corresponding to the second gate line is the M times the clock period.

12. The driver integrated circuit of the display panel of claim 11, wherein when the time length corresponding to the second gate line is the M times the clock period, a second difference between the accumulation error of the second gate line and 1 is a remain accumulation error of the second gate line.

13. The driver integrated circuit of the display panel of claim 12, wherein the plurality of gate lines further comprise a third gate line,
wherein the adder is further configured to add the remain accumulation error of the second gate line and the decimal set value to be the accumulation error of the third gate line,
wherein when the accumulation error of the third gate line is less than 1, the time length corresponding to the third gate line is the N times the clock period,
wherein when the accumulation error of the third gate line is equal to or greater than 1, the time length corresponding to the third gate line is the M times the clock period.

14. A driver integrated circuit of a display panel, comprising:
a source driver coupled to the display panel; and
a controller coupled to the source driver and configured to output a plurality of gate clock signals to a gate driver according to a horizontal synchronous signal, wherein the gate driver is coupled to the display panel through a plurality of gate lines,
wherein the horizontal synchronous signal is generated according to at least one table, and the at least one table records K time intervals of the horizontal synchronous signal for K gate lines of the plurality of gate lines,
wherein an average time length of the K time intervals corresponds to an ideal scan time of the display panel.

15. The driver integrated circuit of the display panel of claim 14, wherein the K time intervals comprise at least one first time interval and at least one second time interval, the at least one first time interval is equal to M times a clock period of a clock signal, and the second time interval is equal to N times the clock period,
wherein the M times the clock period is less than the ideal scan time, and the N times the clock period is greater than the ideal scan time.

16. The driver integrated circuit of the display panel of claim 15, wherein N is equal to M plus 1.

17. The driver integrated circuit of the display panel of claim 15, wherein the at least one table comprise a first table and a second table, and a first order of time lengths of the K time intervals in the first table is different from a second order of time lengths of the K time intervals in the second table.

18. The driver integrated circuit of the display panel of claim 14, wherein the controller further comprises:
a storage circuit configured to store the at least one table.

19. A driver integrated circuit of a display panel, comprising:
a source driver coupled to the display panel; and
a controller coupled to the source driver and configured to output a first gate clock signal and a second gate clock signal to a gate driver according to a horizontal synchronous signal, wherein the gate driver is coupled to the display panel through a first gate line and a second gate line,
wherein a first time length of a first time interval of the first gate clock signal is different from a second time length of a second time interval of the second gate clock signal according to the horizontal synchronous signal which is determined by accumulation errors of the first gate line and the second gate line.

20. A driver integrated circuit of a display panel, comprising:
a source driver coupled to the display panel; and
a controller coupled to the source driver and configured to output a gate clock signal to a gate driver according to a horizontal synchronous signal, wherein the gate driver is coupled to the display panel through a plurality of gate lines,
wherein a first time length of a first time interval of the gate clock signal is different from a second time length of a second time interval of the gate clock signal according to the horizontal synchronous signal which is determined by accumulation errors of the plurality of gate lines.
